(19) United States
(12) Patent Application Publication
(10) Pub. No.: US 2025/0375759 A1
(43) Pub. Date: Dec. 11, 2025

(54) COBALT- AND STRONTIUM-BASED CATALYST FOR THE CONVERSION OF HYDROCARBONS TO SYNTHESIS GAS

(71) Applicant: BASF SE, Ludwigshafen am Rhein (DE)

(72) Inventors: Hamideh AHI, Ludwigshafen am Rhein (DE); Stefan DIETRICH, Ludwigshafen am Rhein (DE); Manuel Frederik GENTZEN, Ludwigshafen am Rhein (DE); Michael KRAEMER, Ludwigshafen am Rhein (DE); Nils BOTTKE, Ludwigshafen am Rhein (DE); Stephan A. SCHUNK, Heidelberg (DE); Virginie LANVER, Ludwigshafen am Rhein (DE); Sandra MAGNUS, Ludwigshafen am Rhein (DE)

(21) Appl. No.: 18/879,865

(22) PCT Filed: Jun. 30, 2023
(86) PCT No.: PCT/EP2023/067990

§ 371 Date: Dec. 30, 2024

(30) Foreign Application Priority Data
Jul. 1, 2022 (EP) 22182594.6

(51) Int. Cl. B01J 23/83; B01J 35/30; B01J 37/00; B01J 37/04; B01J 37/08; B01J 37/16; C01B 3/40

(52) U.S. Cl. CPC B01J 23/83; B01J 35/394; B01J 37/0036; B01J 37/04; B01J 37/088; B01J 37/16; C01B 3/40; C01B 2203/0227; C01B 2203/1052; C01B 2203/1235

(57) ABSTRACT

The present invention relates to a composite oxide comprising oxygen, lanthanum, aluminum, strontium, and cobalt, wherein the Co:Sr weight ratio of cobalt relative to strontium in the composite oxide, calculated as the elements, is in the range of from 0.01:1 to 20:1, as well as to a method for the production of such a composite oxide, to a method for the production of a catalyst for the conversion of hydrocarbons to synthesis gas, and to a catalyst for the conversion of hydrocarbons to synthesis gas obtained from such a method. Finally the present invention relates to a process for the conversion of hydrocarbons to synthesis gas.

### TECHNICAL FIELD

The present invention relates to a composite oxide comprising oxygen, lanthanum, aluminum, strontium, and cobalt, wherein the composite oxide has a specific Co:Sr weight ratio. Further, the present invention relates to a method for the production of a composite oxide and a composite oxide obtainable or obtained by said method. Yet further, the present invention relates to a method for the production of a catalyst for the conversion of hydrocarbons to synthesis gas, and a catalyst obtainable or obtained by said method. Yet further, the present invention relates to a process for the conversion of hydrocarbons to synthesis gas.

### DETAILED DESCRIPTION

Ni- or Co-containing oxide-based catalysts are commonly used for the reforming of hydrocarbons to synthesis gas. Applying Co-containing catalysts lowers the production cost since they allow a lower content of steam in the feed. However, difficulties in the activation of the Co-containing catalysts due to a special activation procedure which is required regularly leads to an increase in production costs.

WO 2013/118078 A1 relates to a Ni- or Co-containing hexaaluminate catalyst for the reforming of hydrocarbons. WO 2014/135642 A1 concerns a Ni-containing hexaaluminate catalyst for the reforming of hydrocarbons in the presence of CO₂. Similarly, WO 2015/091310 A1 concerns a method for reforming mixtures of hydrocarbons and CO₂. US 2016/0207031 A1 and U.S. Pat. No. 9,566,571 B2 specifically concern a process for producing a catalyst for the reforming of hydrocarbons from a feed gas comprising methane and CO₂.

WO 2014/001423 A1, on the other hand, relates to a high pressure process for the CO₂-reforming of hydrocarbons in the presence of Ir-containing catalysts. WO 2015/135968 A1, for its part, relates to yttrium-containing catalysts for high-temperature CO₂ hydration and/or reforming.

WO 2016/062853 A1 relates to the synthesis of aluminates by flame spray pyrolysis.

Finally, WO 2020/157202 A1 relates to a molding comprising a mixed oxide of lanthanum, aluminum, and cobalt.

Despite the numerous modifications which have been made in the past, there nevertheless remains the need for improved catalyst formulations, in particular with regard to their cost-efficiency, and more particularly with regard to the activation of the Co-containing catalysts for the reforming of hydrocarbons to synthesis gas.

### DETAILED DESCRIPTION

It was therefore an object of the present invention to provide a Co-containing catalyst formulation, and in particular a Co-containing catalyst formulation for the conversion of hydrocarbons to synthesis gas in the presence of steam and/or CO₂, wherein the catalyst formulation allows for a more facile activation of the Co-containing catalyst, and in particular wherein the speed at which the catalyst is activated is increased. Thus, it has surprisingly been found that a Co-containing catalyst formulation containing lanthanum, wherein Sr is further included at an Co:Sr weight ratio within a specific range, allows for a substantially higher reducibility of the catalyst at low temperatures, as a results of which the activation of the catalyst is considerably improved, and may thus be achieved it a much shorter time period. As a result, it has quite unexpectedly been found that a Co-containing catalyst may be provided which is highly cost-efficient.

Therefore, the present invention relates to a composite oxide comprising oxygen, lanthanum, aluminum, strontium, and cobalt, wherein the Co:Sr weight ratio of cobalt relative to strontium in the composite oxide, calculated as the elements, is in the range of from 0.01:1 to 20:1, preferably of from 0.03:1 to 10:1, more preferably of from 0.05:1 to 5:1, more preferably of from 0.08:1 to 2:1, more preferably of from 0.10:1 to 1.50:1, more preferably of from 0.15:1 to 1.25:1, more preferably of from 0.20:1 to 1.10:1, more preferably of from 0.25:1 to 0.95:1, more preferably of from 0.30:1 to 0.80:1, more preferably of from 0.35:1 to 0.65:1, more preferably of from 0.40:1 to 0.55:1, and more preferably of from 0.43:1 to 0.47:1.

It is preferred that the composite oxide contains from 1 to 15 wt.-% of cobalt, calculated as the element, more preferably from 2.5 to 12.0 wt.-%, more preferably from 4.0 to 10.5 wt.-%, more preferably from 5.5 to 9.0 wt.-%, more preferably from 6.1 to 8.4 wt.-%, more preferably from 6.3 to 8.2 wt.-%, more preferably from 6.5 to 8.0 wt.-%, more preferably from 6.7 to 7.8 wt.-%, more preferably from 6.8 to 7.7 wt.-%.

It is preferred that the composite oxide contains from 1 to 22.0 wt.-% of strontium, calculated as the element, more preferably from 2.5 to 20.0 wt.-%, more preferably from 4.0 to 18.5 wt.-%, more preferably from 5.0 to 17.5 wt.-%, more preferably from 5.3 to 17.2 wt.-%, more preferably from 5.6 to 16.9 wt.-%, more preferably from 5.8 to 16.7 wt.-%, more preferably from 5.9 to 16.6 wt.-%, more preferably from 6.0 to 16.5 wt.-%.

It is preferred that the composite oxide contains from 3.0 to 20.0 wt.-% of lanthanum, calculated as the element, more preferably from 5.0 to 18.0 wt.-%, more preferably from 6.0 to 17.0 wt.-%, more preferably from 6.8 to 16.2 wt.-%, more preferably from 7.1 to 15.9 wt.-%, more preferably from 7.4 to 15.6 wt.-%, more preferably from 7.6 to 15.4 wt.-%, more preferably from 7.7 to 15.3 wt.-%, more preferably from 7.8 to 15.2 wt.-%.

It is preferred that the composite oxide contains from 26.0 to 45 wt.-% of aluminum, calculated as the element, more preferably from 27.8 to 43.1 wt.-%, more preferably from 28.8 to 42.1 wt. %, more preferably from 29.8 to 41.1 wt.-%, more preferably from 30.3 to 40.6 wt.-%, more preferably from 30.8 to 40.1 wt.-%, more preferably from 31.1 to 39.8 wt.-%, more preferably from 31.3 to 39.6 wt.-%, more preferably from 31.4 to 39.5 wt.-%.

It is preferred that the Co:Al weight ratio of cobalt relative to aluminum in the composite oxide, calculated as the elements, is in the range of from 0.02:1 to 0.50:1, more preferably of from 0.05:1 to 0.45:1, more preferably of from 0.08:1 to 0.38:1, more preferably of from 0.10:1 to 0.33:1, more preferably of from 0.12:1 to 0.30:1, more preferably of from 0.14:1 to 0.27:1, more preferably of from 0.16:1 to 0.25:1, more preferably of from 0.18:1 to 0.23:1, more preferably of from 0.19:1 to 0.22:1.

It is preferred that the Sr:La weight ratio of strontium relative to lanthanum in the composite oxide, calculated as the elements, is in the range of from 0.10:1 to 2.70:1, more preferably from 0.20:1 to 2.50:1, more preferably of from 0.30:1 to 2.40:1, more preferably of from 0.40:1 to 2.30:1, more preferably of from 0.50:1 to 2.20:1, more preferably of from 0.60:1 to 2.10:1, more preferably of from 0.64:1 to 2.06:1, more preferably of from 0.66:1 to 2.04:1, more preferably of from 0.67:1 to 2.03:1.

It is preferred that the composite oxide comprises a SrAl₁₂O₁₉ phase.

In case where the composite oxide comprises a SrAl₁₂O₁₉ phase, it is preferred that the composite oxide comprises the SrAl₁₂O₁₉ phase in an amount ranging from 10 to 80 wt.-% based on 100 wt.-% of the composite oxide, more preferably from 15 to 70 wt.-%, more preferably from 20 to 60 wt.-%, 25 to 55 wt.-%, more preferably from 30 to 53 wt.-%, more preferably from 35 to 51 wt.-%, more preferably from 37 to 49 wt.-%, more preferably from 39 to 47 wt.-%, and more preferably from 41 to 45 wt.-%, wherein the amount of the SrAl₁₂O₁₉ phase in the composite oxide is preferably determined according to the method of Reference Example 1.

It is preferred that the composite oxide comprises a Sr(Al₂O₄) phase.

In case where the composite oxide comprises a Sr(Al₂O₄) phase, it is preferred that the composite oxide comprises the Sr(Al₂O₄) phase in an amount ranging from 0.5 to 50 wt.-% based on 100 wt.-% of the composite oxide, more preferably from 1 to 40 wt.-%, more preferably from 2 to 30 wt.-%, more preferably from 3 to 25 wt.-%, 3 to 25 wt.-%, more preferably from 4 to 20 wt.-%, more preferably from 5 to 18 wt.-%, more preferably from 6 to 15 wt.-%, more preferably from 7 to 12 wt.-%, and more preferably from 8 to 10 wt.-%, wherein the amount of the Sr(Al₂O₄) phase in the composite oxide is preferably determined according to the method of Reference Example 1.

It is preferred that the composite oxide comprises a LaSrAl₃O₇ phase.

In case where the composite oxide comprises a LaSrAl₃O₇ phase, it is preferred that the composite oxide comprises the LaSrAl₃O₇ phase in an amount ranging from 0 to 6 wt.-% based on 100 wt.-% of the composite oxide, more preferably from 0.1 to 4 wt.-%, more preferably from 0.2 to 3 wt.-%, more preferably from 0.4 to 2.5 wt.-%, more preferably from 0.6 to 2 wt.-%, 0.6 to 2 wt.-%, more preferably from 0.8 to 1.8 wt.-%, more preferably from 1.0 to 1.6 wt.-%, and more preferably from 1.2 to 1.4 wt.-%,

wherein the amount of the LaSrAl₃O₇ phase in the composite oxide is preferably determined according to the method of Reference Example 1.

It is preferred that the composite oxide comprises a LaAlO₃ phase.

In case where the composite oxide comprises a LaAlO₃ phase, it is preferred that the composite oxide comprises the LaAlO₃ phase in an amount ranging from 1 to 35 wt.-% based on 100 wt.-% of the composite oxide, more preferably from 3 to 32 wt.-%, more preferably from 5 to 30 wt.-%, 10 to 28 wt.-%, more preferably from 12 to 25 wt.-%, more preferably from 13 to 23 wt.-%, more preferably from 15 to 20 wt.-%, and more preferably from 17 to 18 wt.-%, wherein the amount of the LaAlO₃ phase in the composite oxide is preferably determined according to the method of Reference Example 1.

It is preferred that the composite oxide comprises a CoAl₂O₄ phase, more preferably a CoAl₂O₄ spinel phase.

In case where the composite oxide comprises a CoAl₂O₄ phase, preferably a CoAl₂O₄ spinel phase, it is further preferred that the composite oxide comprises the CoAl₂O₄ phase in an amount ranging from 15.4 to 40 wt.-% based on 100 wt.-% of the composite oxide, more preferably from 16.4 to 32 wt.-%, more preferably from 17.4 to 28 wt.-%, more preferably from 17.9 to 26 wt.-%, more preferably from 19 to 24 wt.-%, more preferably from 19.5 to 23 wt.-%, more preferably from 20 to 22 wt.-%,

wherein the amount of the CoAl₂O₄ phase in the composite oxide is preferably determined according to the method of Reference Example 1.

It is preferred that the composite oxide comprises a Sr₂CoO₄ phase.

In case where that the composite oxide comprises a Sr₂CoO₄ phase, it is preferred that the composite oxide comprises the Sr₂CoO₄ phase in an amount ranging from 1 to 20 wt.-% based on 100 wt.-% of the composite oxide, more preferably from 3 to 16 wt.-%, 4 to 14 wt.-%, more preferably from 5 to 12 wt.-%, more preferably from 6 to 10 wt.-%, and more preferably from 7 to 8 wt.-%,

wherein the amount of the Sr₂CoO₄ phase in the composite oxide is preferably determined according to the method of Reference Example 1.

It is preferred that the composite oxide comprises 1 wt.-% or less of a LaCoAl₁₁O₁₉ phase based on 100 wt.-% of the composite oxide, more preferably 0.5 wt.-% or less, more preferably 0.1 wt. % or less, more preferably 0.05 wt.-% or less, more preferably 0.01 wt.-% or less, more preferably 0.005 wt.-% or less, and more preferably 0.001 wt.-% or less, wherein more preferably the composite oxide comprises no LaCoAl₁₁O₁₉ phase, wherein the amount of LaCoAl₁₁O₁₉ phase in the composite oxide is preferably determined according to the method of Reference Example 1.

It is preferred that the composite oxide displays a crystallinity in the range of from 30 to 95%, more preferably of from 38 to 87%, more preferably of from 43 to 82%, more preferably of from 46 to 79%, more preferably of from 48 to 77%, more preferably of from 49 to 76%, wherein the crystallinity of the composite oxide is preferably determined according to the method of Reference Example 1.

It is preferred that from 99 to 100 weight-%, more preferably from 99.5 to 100 weight-%, more preferably from 99.9 to 100 weight-% of the composite oxide consists of oxygen, lanthanum, aluminum, strontium, cobalt, and optionally hydrogen.

It is preferred that the composite oxide is in the form of a powder or a molding, more preferably in the form of a molding.

In case where the composite oxide is in the form of a powder or a molding, preferably in the form of a molding, it is further preferred that from 99 to 100 weight-%, more preferably from 99.5 to 100 weight-%, more preferably from 99.9 to 100 weight-% of the powder or of the molding consists of the composite oxide.

It is preferred that the composite oxide is obtained or obtainable according to the method of any one of the particular and preferred embodiments of the present invention for the production of a composite oxide.

The present invention also relates to a method for the production of a composite oxide, preferably of a composite oxide according to any one of the particular and preferred embodiments of the present invention, the process comprising
(i) preparing a mixture of one or more sources of Al, one or more sources of Co, one or more sources of strontium, and one or more sources of La;
(ii) adding an acidic aqueous solution to the mixture prepared in (i);
(iii) homogenizing the mixture obtained in (ii);
(iv) optionally shaping the mixture obtained in (iii), preferably by extrusion, for obtaining a shaped body;
(v) optionally drying the mixture obtained in (iii) or the shaped body obtained in (iv);
(vi) optionally pre-calcining the mixture obtained in (iii) or (v), or the shaped body obtained in (iv) or (v);
(vii) optionally milling the dried and/or pre-calcined mixture or shaped body obtained in (v) or (vi);
(viii) optionally tableting the ground product obtained in (vii);
(ix) calcining the mixture obtained in (iii), (v), or (vi), or the shaped body obtained in (iv), (v), or (vi), or the ground product obtained in (vii), or the tableted product obtained in (viii).

In this regard, it is preferred that the one or more sources of Al is selected from the group consisting of aluminum trihydroxide, Al₂O₃·0.5H₂O, Al₂O₃, AlO(OH), more preferably boehmite, sodium aluminate, mixtures of two or more thereof, preferably from the group consisting of gibbsite (alpha-aluminum trihydroxide), bayerite (beta-aluminum trihydroxide), nordstrandite (gamma-aluminum trihydroxide), pseudoamorphous aluminum trihydroxide, Al₂O₃·0.5H₂O, Al₂O₃, AIO(OH), preferably boehmite, sodium aluminate, and mixtures of two or more thereof, wherein the one or more sources of alumina more preferably is AIO(OH).

It is preferred that the one or more sources of Co is selected from the group consisting of a cobalt carbonate, a cobalt oxalate, a cobalt acetate, a cobalt tartrate, a cobalt formate, a cobalt sulfate, a cobalt sulfide, a cobalt fluoride, a cobalt chloride, a cobalt bromide, a cobalt iodide, and mixtures of two or more thereof, wherein the one or more sources of Co is more preferably a cobalt carbonate, more preferably a cobalt carbonate, wherein the cobalt carbonate more preferably comprises, more preferably is CoCO₃·y H₂O, wherein 0≤y≤7, preferably 0≤y≤6.

It is preferred that the one or more sources of La is selected from the group consisting of a lanthanum carbonate, a lanthanum oxalate, a lanthanum acetate, a lanthanum tartrate, a lanthanum formate, a lanthanum sulfate, a lanthanum sulfide, a lanthanum fluoride, a lanthanum chloride, a lanthanum bromide, a lanthanum iodide, and mixtures of two or more thereof, wherein the one or more sources of La is more preferably a lanthanum carbonate, wherein the lanthanum carbonate more preferably comprises, more preferably is La₂(CO₃)₃·x H₂O, wherein 0≤x≤10, more preferably 0≤x≤6.

It is preferred that the one or more sources of Sr is selected from the group consisting of strontium carbonate, strontium fluoride, strontium chloride, strontium bromide, strontium iodide, strontium sulfate, strontium nitrate, strontium hydroxide, strontium oxide, and mixtures of two or more thereof, wherein the one or more sources of Sr is more preferably strontium carbonate.

It is preferred that the mixture in (i) is prepared by kneading of the one or more sources of Al, Co, Sr, and La.

It is preferred that the acidic aqueous solution added in (ii) comprises one or more of formic acid, acetic acid, propionic acid, nitric acid, nitrous acid, citric acid, tartaric acid, and oxalic acid, more preferably one or more of formic acid and nitric acid, wherein the acidic aqueous solution added in (ii) more preferably comprises formic acid.

It is preferred that homogenizing in (iii) is achieved by agitating, more preferably kneading, the mixture obtained in (ii).

It is preferred that drying in (v) is conducted at a temperature in the range from 80 to 150° C., more preferably in the range of from 95 to 120° C., more preferably in the range of from 100 to 110° C.

It is preferred that drying in (v) is conducted for a duration in the range from 4 to 18 h, more preferably in the range of from 6 to 12 h, more preferably in the range of from 8 to 10 h.

It is preferred that pre-calcination in (vi) is conducted at a temperature in the range from 300 to 600° C., more preferably in the range of from 350 to 500° C., more preferably in the range of from 400 to 450° C.

It is preferred that pre-calcination in (vi) is conducted for a duration in the range from 1 to 8 h, more preferably in the range of from 3 to 5 h, more preferably in the range of from 3.5 to 4.5 h.

It is preferred that calcination in (vi) is conducted at a temperature in the range from 800 to 1500° C., more preferably in the range of from 1000 to 1400° C., more preferably in the range of from 1100 to 1300° C.

It is preferred that calcination in (vi) is conducted for a duration in the range from 1 to 8 h, more preferably in the range of from 3 to 5 h, more preferably in the range of from 3.5 to 4.5 h.

The present invention also relates to a composite oxide as obtainable or obtained according to the method of any one of the particular and preferred embodiments of the present invention for the production of a composite oxide.

The present invention also relates to a method for the production of a catalyst for the conversion of hydrocarbons to synthesis gas, the process comprising
(1) providing a composite oxide according to any one of the particular and preferred embodiments of the present invention, or preparing a composite oxide according to the method of any one of the particular and preferred embodiments of the present invention for the production of a composite oxide;
(2) reduction of the composite oxide prepared in (1) for obtaining a catalyst.

It is preferred that reduction in (2) is conducted in an atmosphere comprising one or more reducing agents, wherein the one or more reducing agents comprise one or more of methane, hydrogen, and carbon monoxide, more preferably methane and/or hydrogen, wherein more preferably methane employed in (2) as the reducing agent.

It is preferred that reduction in (2) is conducted at a temperature in the range of from 500 to 1,200° C., more preferably of from 600 to 1,100° C., more preferably from 700 to 1,050° C., more preferably from 750 to 1,000° C., more preferably from 800 to 950° C., and more preferably from 850 to 900° C.

It is preferred that reduction in (2) is conducted at a pressure in the range of from 5 to 40 bara, more preferably of from 10 to 35 bara, more preferably from 12 to 30 bara, more preferably from 14 to 25 bara, more preferably from 16 to 22 bara, and more preferably from 18 to 20 bara.

It is preferred that reduction in (2) is conducted for a duration in the range of from 0.5 to 24 h, more preferably of from 1 to 18 h, more preferably from 3 to 10 h, and more preferably from 5 to 7 h.

The present invention also relates to a catalyst for the conversion of hydrocarbons to synthesis gas as obtainable or obtained according to the method of any one of the particular and preferred embodiments of the present invention for the production of a catalyst for the conversion of hydrocarbons to synthesis gas.

The present invention also relates to a process for the conversion of hydrocarbons to synthesis gas, the process comprising
(A) providing a composite oxide according to any one of the particular and preferred embodiments of the present invention, or a catalyst for the conversion of hydrocarbons to synthesis gas according to any on of the particular and preferred embodiments of the present invention;
(B) preparing a gas stream comprising one or more hydrocarbons, and one or more of CO₂ and H₂O;
(C) contacting the gas stream prepared in (B) with the composite oxide or the catalyst provided in (A) at a temperature in the range of from 700 to 1,200° C., preferably of from 750 to 1,100° C., more preferably from 800 to 1,050° C., more preferably from 850 to 1,000° C., and more preferably from 900 to 950° C.

It is preferred that gas stream prepared in (B) comprises one or more hydrocarbons, CO₂ and H₂O.

It is preferred that the one or more hydrocarbons are selected from the group consisting of C1-C10 alkanes, more preferably of C1-C8 alkanes, more preferably of C1-C6 alkanes, more preferably of C1-C4 alkanes, more preferably of C1-C3 alkanes, and more preferably of C1-C2 alkanes, wherein more preferably the gas stream prepared in (B) comprises one or more of methane, ethane, and propane, wherein more preferably the gas stream prepared in (B) comprises methane and/or ethane, preferably methane, wherein more preferably the one or more hydrocarbons comprised in the gas stream prepared in (B) consists of methane and/or ethane, preferable of methane.

It is preferred that the gas stream prepared in (B) comprises from 20 to 80 vol.-% of the one or more hydrocarbons, more preferably from 25 to 60 vol.-%, more preferably from 30 to 50 vol.-%, more preferably from 35 to 45 vol.-%, and more preferably from 38 to 42 vol.-%.

It is preferred that the gas stream prepared in (B) comprises from 20 to 80 vol.-% of CO₂, more preferably from 25 to 60 vol.-%, more preferably from 30 to 50 vol.-%, more preferably from 35 to 45 vol.-%, and more preferably from 38 to 42 vol.-%.

It is preferred that the gas stream prepared in (B) comprises from 1 to 30 vol.-% of H₂O, more preferably from 5 to 25 vol.-%, more preferably from 10 to 20 vol.-%, more preferably from 12 to 18 vol.-%, and more preferably from 14 to 16 vol.-%.

It is preferred that the gas stream prepared in (B) further comprises one or more inert gases, wherein the inert gases are more preferably selected from the group consisting of noble gases, nitrogen, and mixtures of two or more thereof, wherein more preferably the gas stream further comprises nitrogen and/or argon, preferably nitrogen.

In case where the gas stream prepared in (B) further comprises one or more inert gases, it is preferred that the gas stream prepared in (B) comprises from 0 to 25 vol.-% of the one or more inert gases, more preferably from 0.5 to 15 vol.-%, more preferably from 1 to 10 vol.-%, more preferably from 3 to 8 vol.-%, and more preferably from 4 to 6 vol. %.

It is preferred that contacting in (C) is conducted at a pressure in the range of from 5 to 40 bara, more preferably from 10 to 35 bara, more preferably from 12 to 30 bara, more preferably from 14 to 25 bara, more preferably from 16 to 22 bara, and more preferably from 18 to 20 bara.

It is preferred that contacting in (C) is conducted at a gas hourly space velocity in the range of from 500 to 25,000 h⁻¹, more preferably from 1,000 to 15,000 h⁻¹, more preferably from 3,000 to 10,000 h⁻¹, more preferably from 4,000 to 8,000 h⁻¹, and more preferably from 5,000 to 7,000 h⁻¹.

The present invention is further illustrated by the following set of embodiments and combinations of embodiments resulting from the dependencies and back-references as indicated. In particular, it is noted that in each instance where a range of embodiments is mentioned, for example in the context of a term such as “The composite oxide of any one of embodiments 1 to 4”, every embodiment in this range is meant to be explicitly disclosed for the skilled person, i.e. the wording of this term is to be understood by the skilled person as being synonymous to “The 50 composite oxide of any one of embodiments 1, 2, 3, and 4”. Further, it is explicitly noted that the following set of embodiments is not the set of claims determining the extent of protection, but represents a suitably structured part of the description directed to general and preferred aspects of the present invention.

1. A composite oxide comprising oxygen, lanthanum, aluminum, strontium, and cobalt, wherein the Co:Sr weight ratio of cobalt relative to strontium in the composite oxide, calculated as the elements, is in the range of from 0.01:1 to 20:1, preferably of from 0.03:1 to 10:1, more preferably of from 0.05:1 to 5:1, more preferably of from 0.08:1 to 2:1, more preferably of from 0.10:1 to 1.50:1, more preferably of from 0.15:1 to 1.25:1, more preferably of from 0.20:1 to 1.10:1, more preferably of from 0.25:1 to 0.95:1, more preferably of from 0.30:1 to 0.80:1, more preferably of from 0.35:1 to 0.65:1, more preferably of from 0.40:1 to 0.55:1, and more preferably of from 0.43:1 to 0.47:1.

2. The composite oxide of embodiment 1, wherein the composite oxide contains from 1 to 15 wt.-% of cobalt, calculated as the element, preferably from 2.5 to 12.0 wt.-%, more preferably from 4.0 to 10.5 wt.-%, more preferably from 5.5 to 9.0 wt.-%, more preferably from 6.1 to 8.4 wt.-%, more preferably from 6.3 to 8.2 wt.-%, more preferably from 6.5 to 8.0 wt.-%, more preferably from 6.7 to 7.8 wt.-%, more preferably from 6.8 to 7.7 wt.-%.

3. The composite oxide of embodiment 1 or 2, wherein the composite oxide contains from 1 to 22.0 wt.-% of strontium, calculated as the element, preferably from 2.5 to 20.0 wt.-%, more preferably from 4.0 to 18.5 wt.-%, more preferably from 5.0 to 17.5 wt.-%, more preferably from 5.3 to 17.2 wt.-%, more preferably from 5.6 to 16.9 wt.-%, more preferably from 5.8 to 16.7 wt.-%, more preferably from 5.9 to 16.6 wt.-%, more preferably from 6.0 to 16.5 wt.-%.

4. The composite oxide of any one of embodiments 1 to 3, wherein the composite oxide contains from 3.0 to 20.0 wt.-% of lanthanum, calculated as the element, preferably from 5.0 to 18.0 wt.-%, more preferably from 6.0 to 17.0 wt.-%, more preferably from 6.8 to 16.2 wt.-%, more preferably from 7.1 to 15.9 wt.-%, more preferably from 7.4 to 15.6 wt.-%, more preferably from 7.6 to 15.4 wt.-%, more preferably from 7.7 to 15.3 wt.-%, more preferably from 7.8 to 15.2 wt.-%.

5. The composite oxide of any one of embodiments 1 to 4, wherein the composite oxide contains from 26.0 to 45 wt.-% of aluminum, calculated as the element, preferably from 27.8 to 43.1 wt.-%, more preferably from 28.8 to 42.1 wt.-%, more preferably from 29.8 to 41.1 wt. %, more preferably from 30.3 to 40.6 wt.-%, more preferably from 30.8 to 40.1 wt.-%, more preferably from 31.1 to 39.8 wt.-%, more preferably from 31.3 to 39.6 wt.-%, more preferably from 31.4 to 39.5 wt.-%.

6. The composite oxide of any one of embodiments 1 to 5, wherein the Co:Al weight ratio of cobalt relative to aluminum in the composite oxide, calculated as the elements, is in the range of from 0.02:1 to 0.50:1, preferably of from 0.05:1 to 0.45:1, more preferably of from 0.08:1 to 0.38:1, more preferably of from 0.10:1 to 0.33:1, more preferably of from 0.12:1 to 0.30:1, more preferably of from 0.14:1 to 0.27:1, more preferably of from 0.16:1 to 0.25:1, more preferably of from 0.18:1 to 0.23:1, more preferably of from 0.19:1 to 0.22:1.

7. The composite oxide of any one of embodiments 1 to 6, wherein the Sr:La weight ratio of strontium relative to lanthanum in the composite oxide, calculated as the elements, is in the range of from 0.10:1 to 2.70:1, preferably from 0.20:1 to 2.50:1, more preferably of from 0.30:1 to 2.40:1, more preferably of from 0.40:1 to 2.30:1, more preferably of from 0.50:1 to 2.20:1, more preferably of from 0.60:1 to 2.10:1, more preferably of from 0.64:1 to 2.06:1, more preferably of from 0.66:1 to 2.04:1, more preferably of from 0.67:1 to 2.03:1.

8. The composite oxide of any one of embodiments 1 to 7, wherein the composite oxide comprises a SrAl₁₂O₁₉ phase.

9. The composite oxide of embodiment 8, wherein the composite oxide comprises the SrAl₁₂O₁₉ phase in an amount ranging from 10 to 80 wt.-% based on 100 wt.-% of the composite oxide, preferably from 15 to 70 wt.-%, more preferably from 20 to 60 wt.-%, 25 to 55 wt.-%, more preferably from 30 to 53 wt.-%, more preferably from 35 to 51 wt.-%, more preferably from 37 to 49 wt.-%, more preferably from 39 to 47 wt.-%, and more preferably from 41 to 45 wt.-%, wherein the amount of the SrAl₁₂O₁₉ phase in the composite oxide is preferably determined according to the method of Reference Example 1.

10. The composite oxide of any one of embodiments 1 to 9, wherein the composite oxide comprises a Sr(Al₂O₄) phase.

11. The composite oxide of embodiment 10, wherein the composite oxide comprises the Sr(Al₂O₄) phase in an amount ranging from 0.5 to 50 wt.-% based on 100 wt.-% of the composite oxide, preferably from 1 to 40 wt.-%, more preferably from 2 to 30 wt.-%, more preferably from 3 to 25 wt.-%, 3 to 25 wt.-%, more preferably from 4 to 20 wt.-%, more preferably from 5 to 18 wt.-%, more preferably from 6 to 15 wt.-%, more preferably from 7 to 12 wt.-%, and more preferably from 8 to 10 wt.-%,

wherein the amount of the Sr(Al₂O₄) phase in the composite oxide is preferably determined according to the method of Reference Example 1.

12. The composite oxide of any one of embodiments 1 to 11, wherein the composite oxide comprises a LaSrAl₃O₇ phase.

13. The composite oxide of embodiment 12, wherein the composite oxide comprises the LaSrAl₃O₇ phase in an amount ranging from 0 to 6 wt.-% based on 100 wt.-% of the composite oxide, preferably from 0.1 to 4 wt.-%, more preferably from 0.2 to 3 wt.-%, more preferably from 0.4 to 2.5 wt.-%, more preferably from 0.6 to 2 wt.-%, 0.6 to 2 wt.-%, more preferably from 0.8 to 1.8 wt.-%, more preferably from 1.0 to 1.6 wt.-%, and more preferably from 1.2 to 1.4 wt.-%,

wherein the amount of the LaSrAl₃O₇ phase in the composite oxide is preferably determined according to the method of Reference Example 1.

14. The composite oxide of any one of embodiments 1 to 13, wherein the composite oxide comprises a LaAlO₃ phase.

15. The composite oxide of embodiment 14, wherein the composite oxide comprises the LaAlO₃ phase in an amount ranging from 1 to 35 wt.-% based on 100 wt.-% of the composite oxide, preferably from 3 to 32 wt.-%, more preferably from 5 to 30 wt.-%, 10 to 28 wt.-%, more preferably from 12 to 25 wt.-%, more preferably from 13 to 23 wt.-%, more preferably from 15 to 20 wt.-%, and more preferably from 17 to 18 wt.-%,

wherein the amount of the LaAlO₃ phase in the composite oxide is preferably determined according to the method of Reference Example 1.

16. The composite oxide of any one of embodiments 1 to 15, wherein the composite oxide comprises a CoAl₂O₄ phase, preferably a CoAl₂O₄ spinel phase.

17. The composite oxide of embodiment 16, wherein the composite oxide comprises the CoAl₂O₄ phase in an amount ranging from

15.4 to 40 wt.-% based on 100 wt.-% of the composite oxide, preferably from 16.4 to 32 wt. %, more preferably from 17.4 to 28 wt.-%, more preferably from 17.9 to 26 wt.-%, more preferably from 19 to 24 wt.-%, more preferably from 19.5 to 23 wt.-%, more preferably from 20 to 22 wt.-%,
wherein the amount of the CoAl₂O₄ phase in the composite oxide is preferably determined according to the method of Reference Example 1.

18. The composite oxide of any one of embodiments 1 to 17, wherein the composite oxide comprises a Sr₂CoO₄ phase.

19. The composite oxide of embodiment 18, wherein the composite oxide comprises the Sr₂CoO₄ phase in an amount ranging from 1 to 20 wt.-% based on 100 wt.-% of the composite oxide, preferably from 3 to 16 wt.-%, 4 to 14 wt.-%, more preferably from 5 to 12 wt.-%, more preferably from 6 to 10 wt.-%, and more preferably from 7 to 8 wt.-%, wherein the amount of the Sr₂CoO₄ phase in the composite oxide is preferably determined according to the method of Reference Example 1.

20. The composite oxide of any one of embodiments 1 to 19, wherein the composite oxide comprises 1 wt.-% or less of a LaCoAl₁₁O₁₉ phase based on 100 wt.-% of the composite oxide, preferably 0.5 wt.-% or less, more preferably 0.1 wt.-% or less, more preferably 0.05 wt.-% or less, more preferably 0.01 wt.-% or less, more preferably 0.005 wt.-% or less, and more preferably 0.001 wt.-% or less, wherein more preferably the composite oxide comprises no LaCoAl₁₁O₁₉ phase,

wherein the amount of LaCoAl₁₁O₁₉ phase in the composite oxide is preferably determined according to the method of Reference Example 1.

21. The composite oxide of any one of embodiments 1 to 20, wherein the composite oxide displays a crystallinity in the range of from 30 to 95%, preferably of from 38 to 87%, more preferably of from 43 to 82%, more preferably of from 46 to 79%, more preferably of from 48 to 77%, more preferably of from 49 to 76%,

wherein the crystallinity of the composite oxide is preferably determined according to the method of Reference Example 1.

22. The composite oxide of any one of embodiments 1 to 21, wherein from 99 to 100 weight-%, preferably from 99.5 to 100 weight-%, more preferably from 99.9 to 100 weight-% of the composite oxide consists of oxygen, lanthanum, aluminum, strontium, cobalt, and optionally hydrogen.

23. The composite oxide of any one of embodiments 1 to 22, wherein the composite oxide is in the form of a powder or a molding, preferably in the form of a molding.

24. The composite oxide of embodiment 23, wherein from 99 to 100 weight-%, preferably from 99.5 to 100 weight-%, more preferably from 99.9 to 100 weight-% of the powder or of the molding consists of the composite oxide.

25. The composite oxide of any one of embodiments 1 to 24, wherein the composite oxide is obtained or obtainable according to the method of any one of embodiments 26 to 37.

26. A method for the production of a composite oxide, preferably of a composite oxide according to any one of embodiments 1 to 24, the process comprising
(i) preparing a mixture of one or more sources of Al, one or more sources of Co, one or more sources of strontium, and one or more sources of La;
(ii) adding an acidic aqueous solution to the mixture prepared in (i);
(iii) homogenizing the mixture obtained in (ii);
(iv) optionally shaping the mixture obtained in (iii), preferably by extrusion, for obtaining a shaped body;
(v) optionally drying the mixture obtained in (iii) or the shaped body obtained in (iv);
(vi) optionally pre-calcining the mixture obtained in (iii) or (v), or the shaped body obtained in (iv) or (v);
(vii) optionally milling the dried and/or pre-calcined mixture or shaped body obtained in (v) or (vi);
(viii) optionally tableting the ground product obtained in (vii);
(ix) calcining the mixture obtained in (iii), (v), or (vi), or the shaped body obtained in (iv), (v), or (vi), or the ground product obtained in (vii), or the tableted product obtained in (viii).

27. The method of embodiment 26, wherein the one or more sources of Al is selected from the group consisting of aluminum trihydroxide, Al₂O₃·0.5H₂O, Al₂O₃, AIO(OH), preferably boehmite, sodium aluminate, mixtures of two or more thereof, preferably from the group consisting of gibbsite (alpha-aluminum trihydroxide), bayerite (beta-aluminum trihydroxide), nordstrandite (gamma-aluminum trihydroxide), pseudoamorphous aluminum trihydroxide, Al₂O₃·0.5H₂O, Al₂O₃, AlO(OH), preferably boehmite, sodium aluminate, and mixtures of two or more thereof, wherein the one or more sources of alumina more preferably is AlO(OH).

28. The method of embodiment 26 or 27, wherein the one or more sources of Co is selected from the group consisting of a cobalt carbonate, a cobalt oxalate, a cobalt acetate, a cobalt tartrate, a cobalt formate, a cobalt sulfate, a cobalt sulfide, a cobalt fluoride, a cobalt chloride, a cobalt bromide, a cobalt iodide, and mixtures of two or more thereof, wherein the one or more sources of Co is preferably a cobalt carbonate, more preferably a cobalt carbonate, wherein the cobalt carbonate more preferably comprises, more preferably is CoCO₃·y H₂O, wherein 0≤y≤7, preferably 0≤y≤6.

29. The method of any one of embodiments 26 to 28, wherein the one or more sources of La is selected from the group consisting of a lanthanum carbonate, a lanthanum oxalate, a lanthanum acetate, a lanthanum tartrate, a lanthanum formate, a lanthanum sulfate, a lanthanum sulfide, a lanthanum fluoride, a lanthanum chloride, a lanthanum bromide, a lanthanum iodide, and mixtures of two or more thereof, wherein the one or more sources of La is preferably a lanthanum carbonate, wherein the lanthanum carbonate more preferably comprises, more preferably is La₂(CO₃)₃·x H₂O, wherein 0≤x≤10, more preferably 0≤x≤6.

30. The method of any one of embodiments 26 to 29, wherein the one or more sources of Sr is selected from the group consisting of strontium carbonate, strontium fluoride, strontium chloride, strontium bromide, strontium iodide, strontium sulfate, strontium nitrate, strontium hydroxide, strontium oxide, and mixtures of two or more thereof, wherein the one or more sources of Sr is preferably strontium carbonate.

31. The method of any one of embodiments 26 to 30, wherein the mixture in (i) is prepared by kneading of the one or more sources of Al, Co, Sr, and La.

32. The method of any one of embodiments 26 to 31, wherein the acidic aqueous solution added in (ii) comprises one or more of formic acid, acetic acid, propionic acid, nitric acid, nitrous acid, citric acid, tartaric acid, and oxalic acid, preferably one or more of formic acid and nitric acid, wherein the acidic aqueous solution added in (ii) more preferably comprises formic acid.

33. The method of any one of embodiments 26 to 32, wherein homogenizing in (iii) is achieved by agitating, preferably kneading, the mixture obtained in (ii).

34. The method of any one of embodiments 26 to 33, wherein drying in (v) is conducted at a temperature in the range from 80 to 150° C., preferably in the range of from 95 to 120° C., more preferably in the range of from 100 to 110° C.

35. The method of any one of embodiments 26 to 34, wherein drying in (v) is conducted for a duration in the range from 4 to 18 h, preferably in the range of from 6 to 12 h, more preferably in the range of from 8 to 10 h.

36. The method of any one of embodiments 26 to 35, wherein pre-calcination in (vi) is conducted at a temperature in the range from 300 to 600° C., preferably in the range of from 350 to 500° C., more preferably in the range of from 400 to 450° C.

37. The method of any one of embodiments 26 to 36, wherein pre-calcination in (vi) is conducted for a duration in the range from 1 to 8 h, preferably in the range of from 3 to 5 h, more preferably in the range of from 3.5 to 4.5 h.

38. The method of any one of embodiments 26 to 37, wherein calcination in (vi) is conducted at a temperature in the range from 800 to 1500° C., preferably in the range of from 1000 to 1400° C., more preferably in the range of from 1100 to 1300° C.

39. The method of any one of embodiments 26 to 38, wherein calcination in (vi) is conducted for a duration in the range from 1 to 8 h, preferably in the range of from 3 to 5 h, more preferably in the range of from 3.5 to 4.5 h.

40. A composite oxide as obtainable or obtained according to the method of any one of embodiments 26 to 39.

41. A method for the production of a catalyst for the conversion of hydrocarbons to synthesis gas, the process comprising
(1) providing a composite oxide according to any one of embodiments 1 to 25 and 40, or preparing a composite oxide according to the method of any one of embodiments 26 to 39;
(2) reduction of the composite oxide prepared in (1) for obtaining a catalyst.

42. The method of embodiment 41, wherein reduction in (2) is conducted in an atmosphere comprising one or more reducing agents, wherein the one or more reducing agents comprise one or more of methane, hydrogen, and carbon monoxide, preferably methane and/or hydrogen, wherein more preferably methane employed in (2) as the reducing agent.

43. The method of embodiment 41 or 42, wherein reduction in (2) is conducted at a temperature in the range of from 500 to 1,200° C., preferably of from 600 to 1,100° C., more preferably from 700 to 1,050° C., more preferably from 750 to 1,000° C., more preferably from 800 to 950° C., and more preferably from 850 to 900° C.

44. The method of any one of embodiments 41 to 43, wherein reduction in (2) is conducted at a pressure in the range of from 5 to 40 bara, preferably of from 10 to 35 bara, more preferably from 12 to 30 bara, more preferably from 14 to 25 bara, more preferably from 16 to 22 bara, and more preferably from 18 to 20 bara.

45. The method of any one of embodiments 41 to 44, wherein reduction in (2) is conducted for a duration in the range of from 0.5 to 24 h, preferably of from 1 to 18 h, more preferably from 3 to 10 h, and more preferably from 5 to 7 h.

46. A catalyst for the conversion of hydrocarbons to synthesis gas as obtainable or obtained according to the method of any one of embodiments 41 to 45.

47. A process for the conversion of hydrocarbons to synthesis gas, the process comprising
(A) providing a composite oxide according to any one of embodiments 1 to 25 and 40, or a catalyst according to embodiment 46;
(B) preparing a gas stream comprising one or more hydrocarbons, and one or more of CO₂ and H₂O;
(C) contacting the gas stream prepared in (B) with the composite oxide or the catalyst provided in (A) at a temperature in the range of from 700 to 1,200° C., preferably of from 750 to 1,100° C., more preferably from 800 to 1,050° C., more preferably from 850 to 1,000° C., and more preferably from 900 to 950° C.

48. The process of embodiment 47, wherein gas stream prepared in (B) comprises one or more hydrocarbons, CO₂ and H₂O.

49. The process of embodiment 47 or 48, wherein the one or more hydrocarbons are selected from the group consisting of C1-C10 alkanes, preferably of C1-C8 alkanes, more preferably of C1-C6 alkanes, more preferably of C1-C4 alkanes, more preferably of C1-C3 alkanes, and more preferably of C1-C2 alkanes, wherein more preferably the gas stream prepared in (B) comprises one or more of methane, ethane, and propane, wherein more preferably the gas stream prepared in (B) comprises methane and/or ethane, preferably methane, wherein more preferably the one or more hydrocarbons comprised in the gas stream prepared in (B) consists of methane and/or ethane, preferable of methane.

50. The process of any one of embodiments 47 to 49, wherein the gas stream prepared in (B) comprises from 20 to 80 vol.-% of the one or more hydrocarbons, preferably from 25 to 60 vol.-%, more preferably from 30 to 50 vol.-%, more preferably from 35 to 45 vol.-%, and more preferably from 38 to 42 vol.-%.

51. The process of any of embodiments 47 to 50, wherein the gas stream prepared in (B) comprises from 20 to 80 vol.-% of CO₂, preferably from 25 to 60 vol.-%, more preferably from 30 to 50 vol.-%, more preferably from 35 to 45 vol.-%, and more preferably from 38 to 42 vol.-%.

52. The process of any one of embodiments 47 to 51, wherein the gas stream prepared in (B) comprises from 1 to 30 vol.-% of H₂O, preferably from 5 to 25 vol.-%, more preferably from 10 to 20 vol.-%, more preferably from 12 to 18 vol.-%, and more preferably from 14 to 16 vol.-%.

53. The process of any one of embodiments 47 to 52, wherein the gas stream prepared in (B) further comprises one or more inert gases, wherein the inert gases are preferably selected from the group consisting of noble gases, nitrogen, and mixtures of two or more thereof, wherein more preferably the gas stream further comprises nitrogen and/or argon, preferably nitrogen.

54. The process of embodiment 53, wherein the gas stream prepared in (B) comprises from 0 to 25 vol.-% of the one or more inert gases, preferably from 0.5 to 15 vol.-%, more preferably from 1 to 10 vol.-%, more preferably from 3 to 8 vol.-%, and more preferably from 4 to 6 vol. %.

55. The process of any one of embodiments 47 to 54, wherein contacting in (C) is conducted at a pressure in the range of from 5 to 40 bara, preferably from 10 to 35 bara, more preferably from 12 to 30 bara, more preferably from 14 to 25 bara, more preferably from 16 to 22 bara, and more preferably from 18 to 20 bara.

56. The process of any one of embodiments 47 to 55, wherein contacting in (C) is conducted at a gas hourly space velocity in the range of from 500 to 25,000 h⁻¹, preferably from 1,000 to 15,000 h⁻¹, more preferably from 3,000 to 10,000 h⁻¹, more preferably from 4,000 to 8,000 h⁻¹, and more preferably from 5,000 to 7,000 h⁻¹.

### DESCRIPTION OF THE FIGURES

FIG. 1 displays the results from TPR analysis of the samples from Examples 1 to 3 as performed according to Reference Example 2, respectively. In the FIGURE, the time in minutes is plotted along the abscissa.

### EXPERIMENTAL SECTION

The present invention is further illustrated by the following Examples, Comparative Examples and Reference Examples.

### Reference Example 1: Compositional and Structural Analysis Via X-Ray Diffraction

The sample is ground using a mill until it is a fine powder. The mill used is a IKA Tube Mill 100. The milling program used is 20′000 rpm for 60 s repeated once.

After that the samples are transferred to a standard sample holder (material PMMA, manufacturer Bruker AXS) and flattened using a glass plate. The samples are measured in a D8 Advance diffractometer (Bruker AXS) using Moka₁ radiation, fixed slits set to 0.1° and a linearly integrating area detector (LynxEye, Bruker AXS) in an angular range of 2°-40° 2theta with a step size of 0.01° 2theta.

The data analysis is performed using the software TOPAS 6 (TOPAS 6 User Manual, Bruker AXS GmbH, Karlsruhe, Germany, 2017). The modelled phase composition is set to: SrAl₁₂O₁₉, CoAl₂O₄, LaAlO₃, SrAl₂O₄, Sr₂CoO₄, LaSrAl₃O₇. In all phases the lattice parameters and crystallite size are refined, The background is modelled using a 3^{rd} order Polynomial. Sample height is also refined. Intensity corrections for Lorentz and polarization effects are considered. The phase quantification is performed is standard procedures described in Klug, H. P. & Alexander, L. E. (1974), X-ray Diffraction Procedures, 2nd ed. New York: John Wiley. An additional cost factor restraining the elemental composition to that which has been measured using elemental analysis techniques (inductively coupled plasma (ICP)) was used to ensure the reliability of the refinement.

### Reference Example 2: Temperature Programmed Reduction (TPR) Analysis

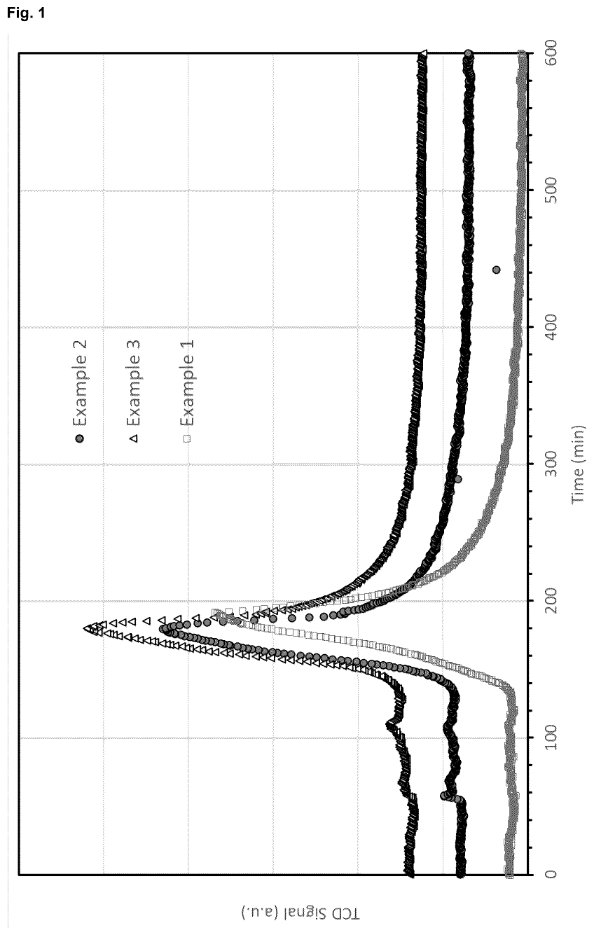

50 The reduction behavior of a molding was determined by temperature programmed reduction. 190 mg of a sample having particles with an average particle size between 0.2 and 0.4 mm were used. As a feed gas a stream of 5 volume-% hydrogen in Argon was used, whereby the feed rate was set to 50 ml/min. The temperature was increased during a measurement from room temperature up to 950° C. with a heating rate of 5 K/min. The thermal conductivity detector (TCD) signal was recorded relative to the temperature to give the TPR profile. The TPR profile of Examples 1-3 are shown in FIG. 1.

### Example 1: Preparation of a Composite Oxide of Co, La, Sr, and Al

160 g aqueous AlOOH (Disperal; Sasol; containing 77.6 weight-% of Al calculated as Al₂O₃), 28.57 g cobalt(II)carbonate hydrate (containing 46 weight-% of Co; Umicore lot29371A0205/BASF SE), 40.23 g lanthanum(III)carbonate hydrate (containing 41 weight-% La; Mongolia Baotuo Steel Rare Earth Int. trade co. ltd) and 17.89 g Strontium carbonate (Sigma_Aldrich_Chemie_Germany_GmbH: containing 58.165 weight-% of Sr) were pre-mixed for several minutes in a Kneader. Then, 120 ml aqueous formic acid (containing 37 weight-% formic acid; based on formic acid having 98-100 weight-%, Bernd Kraft GmbH) were added under mixing and a dough-like homogeneous pink mass was formed.

The kneading mass was then shaped into 3.5 mm ropes. The ropes were dried at 90° C. for 16 h, subsequently calcined for 2 h at 400° C. and then split into particles having an inner diameter of 0.5-1 mm. Prior to catalytic testing the split was calcined. For calcination, the moldings were heated within 3 hours to a temperature of 700° C. and said temperature was held for 1 hour. Then the moldings were heated further to a temperature of 1200° C., and the temperature was held for 4 hours. The calcination was done in an annealing furnace.

Structural analysis via X-ray diffraction data obtained for the calcined sample was performed in accordance with the procedure of Reference Example 1, using the values of the elemental composition of the samples as measured using inductively coupled plasma (ICP) as the elemental analysis technique (see values in Table 1). The Analysis afforded the following results for the phases in the sample and their relative amounts:

| Phase Formula | Wt.-% |
|---|---|
| SrAl₁₂O₁₉ | 57.7 |
| CoAl₂O₄ | 27.9 |
| LaAlO₃ | 10.3 |
| Sr₂CoO₄ | 3.0 |
| SrAl₂O₄ | 1.1 |

### Example 2: Preparation of a Composite Oxide of Co, La, Sr and Al

160 g aqueous AlOOH (Disperal; Sasol; containing 77.6 weight-% of Al calculated as Al₂O₃), 31.1 g cobalt(II)carbonate hydrate (containing 46 weight-% of Co; Umicore lot29371A0205/BASF SE), 80.1 g lanthanum(III)carbonate hydrate (containing 41 weight-% La; Mongolia Baotuo Steel Rare Earth Int. trade co. ltd) and 35.6 g Strontium carbonate (Sigma_Aldrich_Chemie_Germany_GmbH: containing 58.165 weight-% of Sr) were pre-mixed for several minutes in a Kneader. Then, 140 ml aqueous formic acid (containing 51 weight-% formic acid; based on formic acid having 98-100 weight-%, Bernd Kraft GmbH) were added under mixing and a dough-like homogeneous pink mass was formed.

The kneading mass was then shaped into 3.5 mm ropes. The ropes were dried at 90° C. for 16 h, subsequently calcined for 2 h at 400° C. and then split into particles having an inner diameter of 0.5-1 mm. Prior to catalytic testing the split was calcined. For calcination, the moldings were heated within 3 hours to a temperature of 700° C. and said temperature was held for 1 hour.

Then the moldings were heated further to a temperature of 1200° C., and the temperature was held for 4 hours. The calcination was done in an annealing furnace.

Structural analysis via X-ray diffraction data obtained for the calcined sample was performed in accordance with the procedure of Reference Example 1, using the values of the elemental composition of the samples as measured using inductively coupled plasma (ICP) as the elemental analysis technique (see values in Table 1). The Analysis afforded the following results for the phases in the sample and their relative amounts:

| Phase Formula | Wt.-% |
|---|---|
| SrAl₁₂O₁₉ | 43.4 |
| CoAl₂O₄ | 21.0 |
| LaAlO₃ | 17.5 |
| SrAl₂O₄ | 9.6 |
| Sr₂CoO₄ | 7.2 |
| LaSrAl₃O₇ | 1.3 |

### Example 3: Preparation of a Composite Oxide of Co, Sr, La, and Al

160 g aqueous AlOOH (Disperal; Sasol; containing 77.6 weight-% of Al calculated as Al₂O₃), 31.1 g cobalt(II)carbonate hydrate (containing 46 weight-% of Co; Umicore lot29371A0205/BASF SE), 40.03 g lanthanum(III)carbonate hydrate (containing 41 weight-% La; Mongolia Baotuo Steel Rare Earth Int. trade co. ltd) and 53.39 g Strontium carbonate (Sigma_Aldrich_Chemie_Germany_GmbH: containing 58.165 weight-% of Sr) were pre-mixed for several minutes in a Kneader. Then, 140 ml aqueous formic acid (containing 51 weight-% formic acid; based on formic acid having 98-100 weight-%, Bernd Kraft GmbH) were added under mixing and a dough-like homogeneous pink mass was formed.

The kneading mass was then shaped into 3.5 mm ropes. The ropes were dried at 90° C. for 16 h, subsequently calcined for 2 h at 400° C. and then split into particles having an inner diameter of 0.5-1 mm. Prior to catalytic testing the split was calcined. For calcination, the moldings were heated within 3 hours to a temperature of 700° C. and said temperature was held for 1 hour. Then the moldings were heated further to a temperature of 1200° C., and the temperature was held for 4 hours. The calcination was done in an annealing furnace.

Structural analysis via X-ray diffraction data obtained for the calcined sample was performed in accordance with the procedure of Reference Example 1, using the values of the elemental composition of the samples as measured using inductively coupled plasma (ICP) as the elemental analysis technique (see values in Table 1). The Analysis afforded the following results for the phases in the sample and their relative amounts:

| Phase Formula | Wt.-% |
|---|---|
| SrAl₁₂O₁₉ | 38.1 |
| SrAl₂O₄ | 25.5 |
| CoAl₂O₄ | 18.6 |
| LaAlO₃ | 12.4 |
| Sr₂CoO₄ | 4.8 |
| LaSrAl₃O₇ | 0.6 |

### Characterisation of Catalysts

The elemental analysis of samples from Examples 1 to 3 is displayed in Table 1.

TABLE 1
Elemental analysis of the samples from the examples as obtained from
inductively coupled plasma (ICP) (after the second calcination step).

| | | | | | Co:Al | Co:Sr | Sr:La |
|---|---|---|---|---|---|---|---|
| | Al | Co | La | Sr | [weight | [weight | [weight |
| | [wt.-%] | [wt.-%] | [wt.-%] | [wt.-%] | ratio] | ratio] | ratio] |
| Example 1 | 39 | 7.6 | 9.1 | 6.1 | 0.19 | 1.25 | 0.67 |
| Example 2 | 31.5 | 6.9 | 15.1 | 10.3 | 0.22 | 0.67 | 0.68 |
| Example 3 | 33 | 7.2 | 7.9 | 16 | 0.22 | 0.45 | 2.03 |

From the results from TPR analysis performed on Examples 1 to 3 which are displayed in FIG. 1, it is noticeable that by lowering the Co:Sr weight ratio, lower temperature peaks increasingly appear in TPR, which have positive influence on activation behavior.

Thus, it has surprisingly been found that a Co-containing catalyst formulation containing lanthanum, wherein Sr is further included at an Co:Sr weight ratio within a specific range, allows for a substantially higher reducibility of the catalyst at low temperatures, as a results of which the activation of the catalyst is considerably improved, and may thus be achieved in a much shorter time period.

### CITED LITERATURE

WO 2013/118078 A1
WO 2014/135642 A1
WO 2015/091310 A1
US 2016/0207031 A1
U.S. Pat. No. 9,566,571 B2
WO 2014/001423 A1
WO 2015/135968 A1
WO 2016/062853 A1
WO 2020/157202 A1

1.-15. (canceled)

16. A composite oxide comprising oxygen, lanthanum, aluminum, strontium, and cobalt, wherein the Co:Sr weight ratio of cobalt relative to strontium in the composite oxide, calculated as the elements, is in the range of from 0.01:1 to 20:1.

17. The composite oxide of claim 16, wherein the composite oxide contains from 1 to 15 wt.-% of cobalt, calculated as the element.

18. The composite oxide of claim 16, wherein the composite oxide contains from 1 to 22.0 wt.-% of strontium, calculated as the element.

19. The composite oxide of claim 16, wherein the composite oxide contains from 3.0 to 20.0 wt.-% of lanthanum, calculated as the element.

20. The composite oxide of claim 16, wherein the composite oxide contains from 26.0 to 45 wt.-% of aluminum, calculated as the element.

21. The composite oxide of claim 16, wherein the composite oxide comprises a SrAl₁₂O₁₉ phase.

22. The composite oxide of claim 16, wherein the composite oxide comprises a Sr(Al₂O₄) phase.

23. The composite oxide of claim 16, wherein the composite oxide comprises a LaSrAl₃O₇ phase.

24. The composite oxide of claim 16, wherein the composite oxide comprises a LaAlO₃ phase.

25. The composite oxide of claim 16, wherein the composite oxide comprises a CoAl₂O₄ phase.

26. The composite oxide of claim 16, wherein the composite oxide comprises a Sr₂CoO₄ phase.

27. A method for the production of a composite oxide according to claim 16, the process comprising
(i) preparing a mixture of one or more sources of Al, one or more sources of Co, one or more sources of strontium, and one or more sources of La;
(ii) adding an acidic aqueous solution to the mixture prepared in (i);
(iii) homogenizing the mixture obtained in (ii);
(iv) optionally shaping the mixture obtained in (iii) for obtaining a shaped body;
(v) optionally drying the mixture obtained in (iii) or the shaped body obtained in (iv);
(vi) optionally pre-calcining the mixture obtained in (iii) or (v), or the shaped body obtained in (iv) or (v);
(vii) optionally milling the dried or pre-calcined mixture or shaped body obtained in (v) or (vi);
(viii) optionally tableting the ground product obtained in (vii); and
(ix) calcining the mixture obtained in (iii), (v), or (vi), or the shaped body obtained in (iv), (v), or (vi), or the ground product obtained in (vii), or the tableted product obtained in (viii).

28. A method for the production of a catalyst for the conversion of hydrocarbons to synthesis gas, the process comprising
(1) preparing a composite oxide according to the method of claim 27; and
(2) reducing the composite oxide prepared in (1) for obtaining a catalyst.

29. A catalyst for the conversion of hydrocarbons to synthesis gas obtained according to the method of claim 28.

30. A process for the conversion of hydrocarbons to synthesis gas, the process comprising
(A) providing a composite oxide according to claim 16;
(B) preparing a gas stream comprising one or more hydrocarbons, and one or more of CO₂ and H₂O; and
(C) contacting the gas stream prepared in (B) with the composite oxide provided in (A) at a temperature in the range of from 700 to 1,200° C.
